(19) United States
(12) Patent Application Publication
(10) Pub. No.: US 2009/0314609 A1
(43) Pub. Date: Dec. 24, 2009

(54) ITEM-CONVEYING DEVICE

(76) Inventors: Frank Krakosh, III, Latrobe, PA (US); James K. Monnich, Greensburg, PA (US)

Correspondence Address: DON W. BULSON (PARK);RENNER, OTTO, BOISSELLE & SKLAR, LLP, 1621 EUCLID AVENUE / 19TH FLOOR, CLEVELAND, OH, 44115, US

(21) Appl. No.: 12/359,349

(22) Filed: Jan. 26, 2009

Related U.S. Application Data
(60) Provisional application No. 61/073,500, filed on Jun. 18, 2008.

(51) Int. Cl. B65G 47/91; B65G 43/02

(52) U.S. Cl. 198/464.4; 198/468.4

(57) ABSTRACT

An item-conveying device (20) includes a plate assembly (30) having an arm portion (31) and a spatula portion (32) cantilevered therefrom. The spatula portion (32) has at least one gripping opening (36) and a fluid channel (37) extends from the arm portion (31) to the gripping opening(s) (36). Upon connection of the fluid channel (37) to a vacuum source, a suction will be produced at the gripping opening(s) (36) to hold an item against the spatula portion (32).

### RELATED APPLICATION

This application claims priority under 35 U.S.C. §119(e) to U.S. Provisional Patent Application No. 61/073,500 filed on Jun. 18, 2008. The entire disclosure of this provisional application is hereby incorporated by reference. If incorporated-by-reference subject matter is inconsistent with subject matter expressly set forth in the written specification (and/or drawings) of the present disclosure, the latter governs to the extent necessary to eliminate indefiniteness and/or clarity-lacking issues.

### FIELD

A device for conveying flat-surface items that are compiled in a bank (e.g., a vertical stack, a horizontal rack, a diagonal row, a multi-dimensional array, etc.) with only a thin gap between adjacent items.

### BACKGROUND

Flat-surface items, such as data-containing discs, are often compiled in a bank, with the items being compartmentalized within receptacles or other separating structure. The bank can, for example, resemble a vertical-stack structure in which the items are oriented with their major surfaces substantially horizontal. Adjacent items (and/or items and neighboring receptacles) are separated by a clearance. When space limitations or other factors are of concern, it may be preferable for such clearances to be as small as possible. If so, the device used to convey the items to/from the bank (i.e., the item-conveying device) must be able to accommodate such narrow clearances.

### SUMMARY

An item-conveying device comprises a spatula portion that can be constructed to have a very thin profile, thereby allowing accommodation of narrow clearances in compilation banks. The spatula portion can be part of a plate assembly (comprising a plurality of thin plates assembled together) that can slip small gaps and suction grip the intended-to-be-conveyed item. The item-conveying device can additionally or alternatively comprise a system to detect possible malfunctions in a conveying situation (e.g., a jammed item, unexpected load, etc.) so that damage to the device can be circumvented.

### DRAWINGS

FIG. 1 is a schematic view of flat-surface items 10 compiled in a bank 11.

FIGS. 2A-2C are perspective and exploded views of a device 20 for conveying the flat-surface items 10 compiled in the bank 11 shown in FIG. 1.

FIGS. 3A-3C are perspective and exploded views of a plate assembly 30 of the item-conveying device 20.

FIGS. 4A-4C are plan and side views of a plate 40 of the plate assembly 30.

FIGS. 5A-5C are plan and side views of a plate 50 of the plate assembly 30.

FIGS. 6A-6C are plan and side views of a plate 60 of the plate assembly 30.

FIGS. 7A-7C are plan and side views of a housing 70 of the item-conveying device 20.

FIGS. 8A-8F are plan and side views of a bracket 80 for the item-conveying device 20.

FIGS. 9A-9E are plan and side views of a damage-detection system 90 of the item-conveying device 20.

### DESCRIPTION

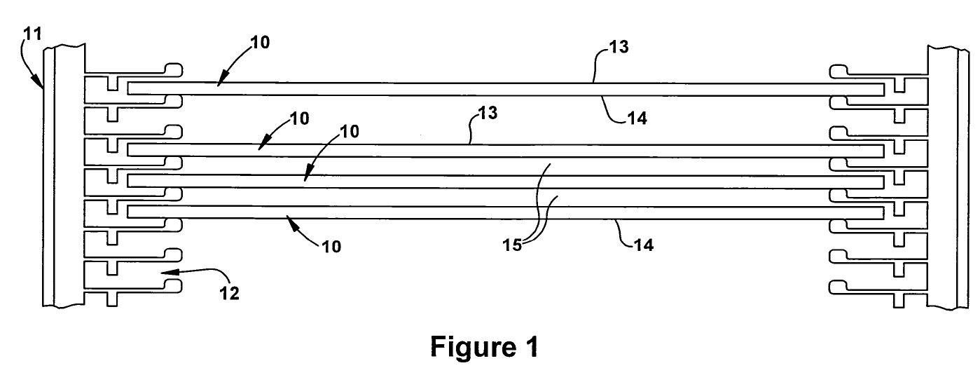

Referring now to the drawings, and initially to FIG. 1, a plurality of items 10 are shown compiled in a bank 11, the items 10 being compartmentalized within receptacles 12 or other separating structure. The items 10 can each have a thin profile with a flat top surface 13 and/or a flat bottom surface 14. For example, the items 10 can comprise circular-shaped objects (e.g., media-containing discs, wafers, etc.). In the illustrated embodiment, the bank 11 resembles a vertical-stack structure and the items 10 are oriented so that their major surfaces 13/14 are substantially horizontal. But other bank arrangements (e.g., horizontal racks, diagonal rows, multi-dimensional arrays) and/or item orientations are certainly contemplated. In either or any event, adjacent items 10 (and/or items and neighboring receptacles 12) are separated by a clearance 15.

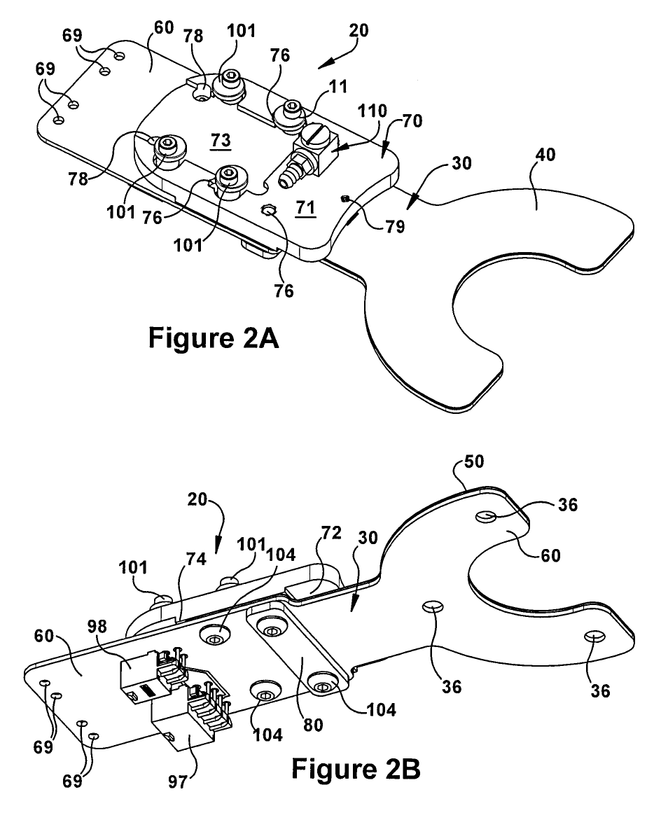

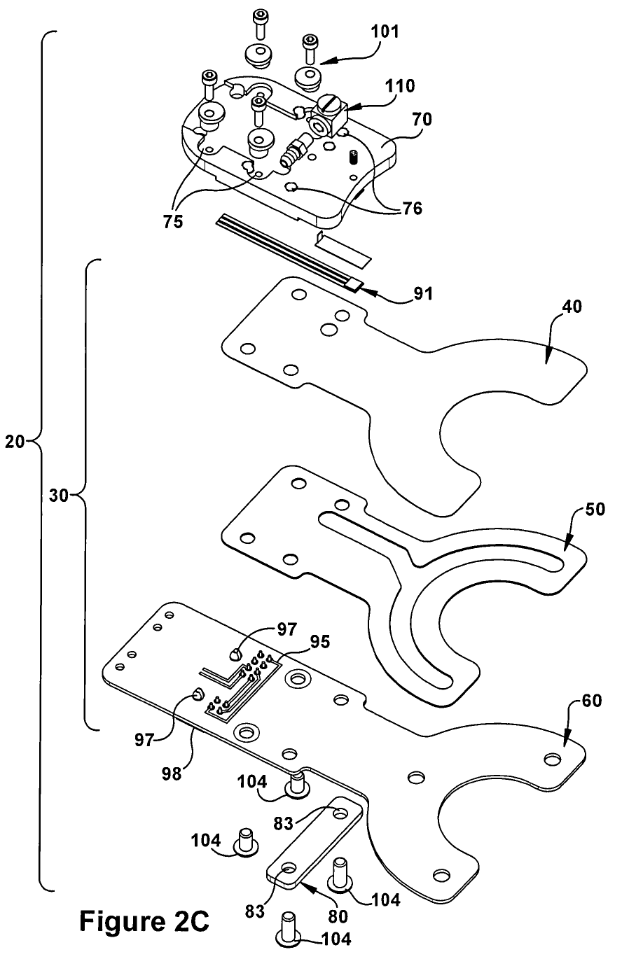

Referring now to the 2^{nd} set of drawings (FIGS. 2A-2C), a device 20 for removing, inserting, carrying, lifting, moving, transporting or otherwise conveying the items 10 is shown. The item-conveying device 20 generally comprises a plate assembly 30, (including plates 40, 50, 60), housing 70, a bottom bracket 80, and a damage-detection system 90. (System 90 is referenced in the 9^{th} drawing set.) Fasteners 101 (e.g., rivets) can be used to attach these components together and fasteners 104 can be used to attach the device 20 to a movement-manipulating arm. A fitting 110 can be provided for connection to a vacuum source (not shown).

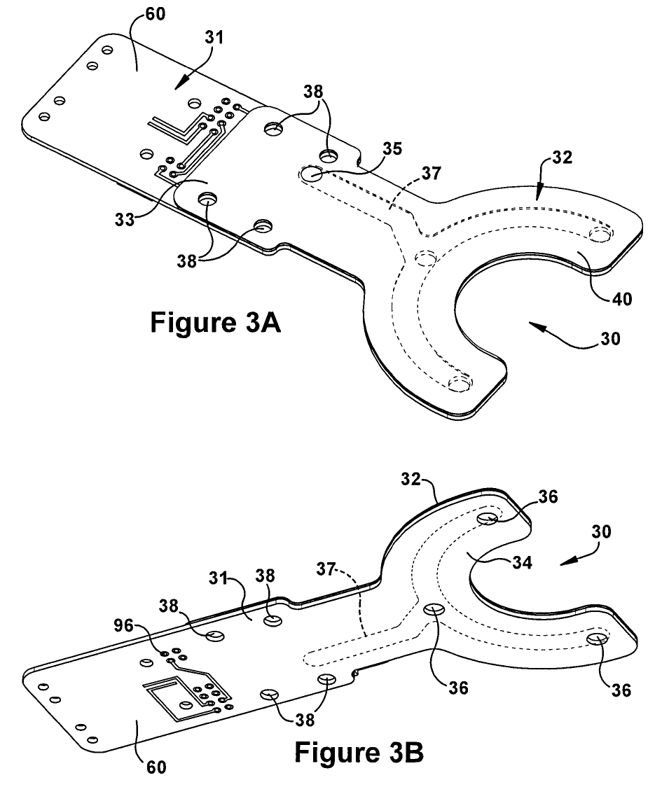

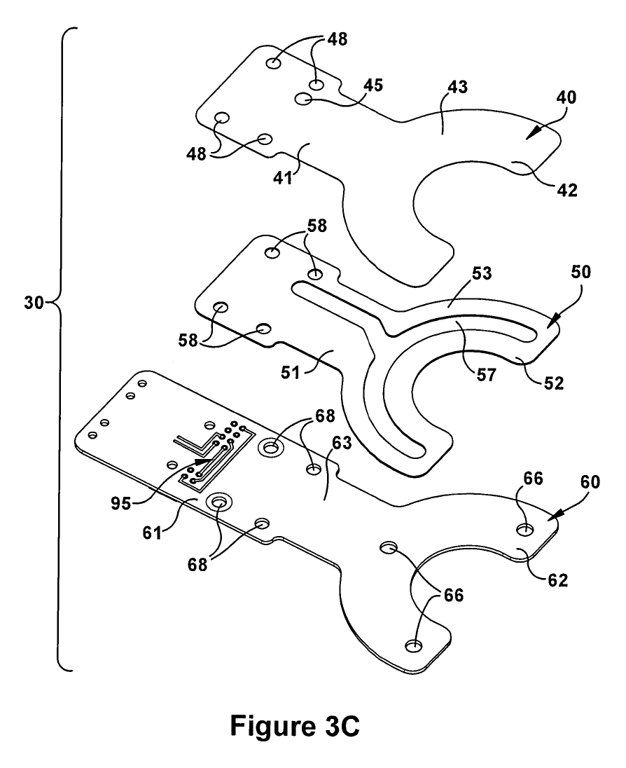

The plate assembly 30, which is shown isolated from the rest of the item-conveying device 20 in the 3^{rd} drawing set (FIGS. 3A-3C), comprises an arm portion 31 and a spatula portion 32. The arm portion 31 can be adapted for attachment to a mechanism (e.g., a robotic link, not shown) to alienate the device 20 with the to-be-conveyed item 10. The spatula portion 32 cantilevers from the arm portion 31 and is adapted for placement flush against a major surface 13/14 of the item.

The plate assembly 30 has an exposed non-gripping surface 33 (visible in FIG. 3A) and an exposed gripping surface 34 (visible in FIG. 3B). In the illustrated orientation, the non-gripping surface 33 is the top surface and the gripping surface 34 is the bottom surface. This orientation corresponds to the acclimation of the item 10 and/or the assimilation of the bank 11. Specifically, the illustrated conveying device 20 is intended to grip the top surface 13 of the item 10 whereby its gripping surface 34 is its bottom surface. If the device 20 was intended to instead grip the bottom surface 14 of the item 10, its gripping surface 34 would instead be its top surface. Likewise, if the item 10 was disposed sideways, its gripping surface 34 would be orientated at a similar angle.

A fitting-connection port 35 (for connection to the fitting 110) is situated on the top (non-gripping) surface 33 of the arm portion 31. Suction openings 36 are situated on the bottom (gripping) surface 34 of the spatula portion 32. And a fluid channel 37 is situated within the plate assembly 30 (i.e., between the surfaces 33 and 34), and fluidly connects the openings 36 to the port 35.

When the fluid channel 37 is connected to a vacuum source (e.g., via the port 35 and the fitting 92), item-gripping suction is produced at the openings 36. Thus, when the spatula portion 32 is placed flush against a major surface 13/14 of an item, suction is produced at the openings 36 to thereby grip the item 10. By then moving the spatula portion 32 relative to the bank 11 (e.g., by a movement-manipulating mechanism attached to the arm portion 31 via the fasteners 104), the gripped item 10 can be conveyed as desired.

The plate assembly 30 can further comprise fastener holes 38 for receipt of the fasteners 101 and attachment to the housing 70. The holes 38 can be situated on the arm portion 31 of the assembly 30, and extend entirely therethrough (i.e., from its top surface 33 to its bottom surface 34). The holes 38 can be spaced a sufficient distance from the spatula portion 32, so that the fasteners 101 will not interfere with its insertion into narrow clearances.

The illustrated plate assembly 30 comprises plates 40, 50, and 60, which are shown in more detail in the 4^{th}, 5^{th}, and 6^{th} drawing sets (FIG. 3C), respectively. The plate 40 (the top plate in the illustrated orientation) can be considered the item-remote plate as it is positioned most remote from the to-be-conveyed item 10. The plate 50 can be considered the intermediate plate. The plate 60 (the bottom plate in the illustrated orientation) can be considered the item-adjacent plate as it is positioned most adjacent to the to-be-conveyed item 10. As with the assembly 30, the orientation of the plates corresponds to that of the items 10 and/or the bank 11.

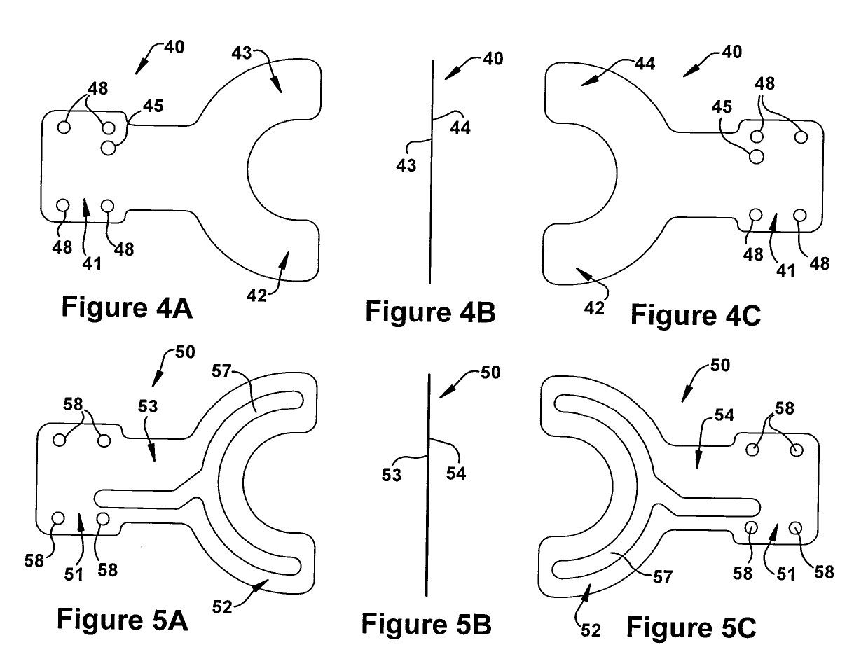

The top (item-remote) plate 40 comprises an arm section 41 and a spatula section 42, the intermediate plate 50 comprises an arm section 51 and a spatula section 52, and the bottom (item-adjacent) plate 60 comprises an arm section 61 and a spatula section 62. The plates 40, 50, 60 can each be viewed as having an item-remote face 43, 53, 63 and an item-adjacent face 44, 54, 64 which, in the illustrated orientation are upper and lower faces, respectively (See FIGS. 4A-C, 5A-C, 6A-C).

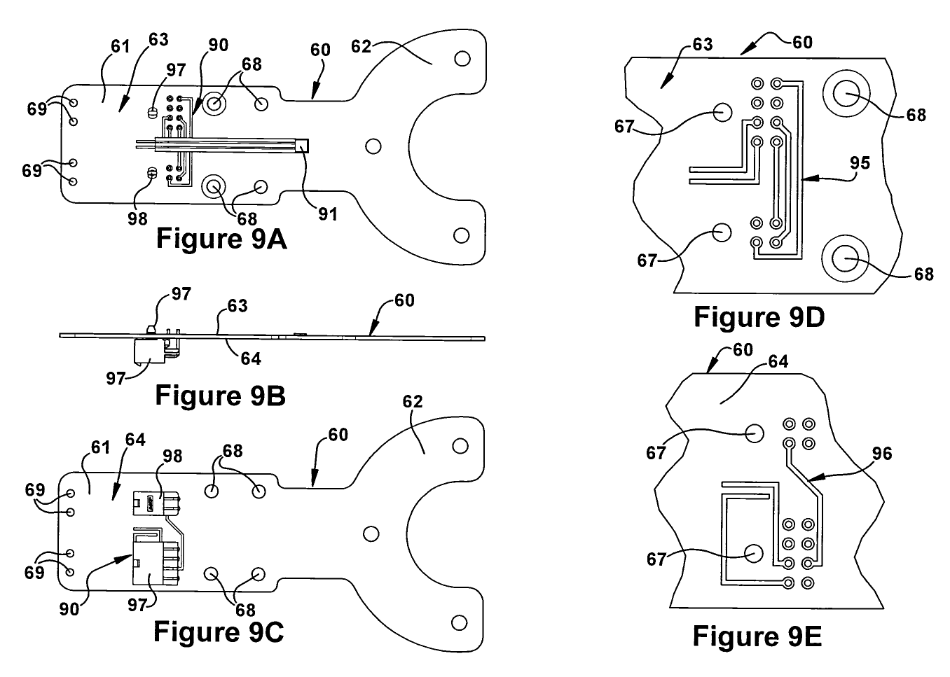

The plates 40, 50, 60 are assembled so that their respective arm sections 41, 51, 61 form the arm portion 31 of the plate assembly 30, and their respective spatula sections 42, 52, 62 form the spatula portion 32 of the plate assembly. In the illustrated plate assembly 30, the arm sections 41 and 51 have substantially the same plan shape and size (e.g., roughly rectangular). The arm section 61 has a similar shape/size, but also includes a proximal extension that projects therebeyond. The arm-section shape/size can be selected for engagement with the housing 70, for cooperation with the damage-detection system 90 (FIG. 9A), for coordination with alienating machinery, and/or for compatibility with the structural members of the bank 11 in which the items 10 reside.

The illustrated spatula sections 42, 52, 62 have substantially the same plan shape and size. The spatula shape/size can be selected to correspond to the expected geometry of the items 10 to be conveyed. For example, and as shown, the spatula portion 32 and/or the spatula sections 42, 52, 62 can have a semi-annular shape, with a semi-circular outer perimeter (that translates into the arm portion 31) and a semi-circular inner perimeter.

The plates 40, 50, 60 have apertures, grooves, and/or other features, in compiled plate assembly 30, some or all of which coordinate to form the port 35, the openings 36, the channel 37, and/or the fastener holes 38. More specifically, in the illustrated embodiment, the plate 40 includes apertures 45 and 48, and the plate 50 includes groove 57 and aperture 58. The plate 60 can include apertures 66, 67, 68, and 69.

In the completed plate assembly 30, the aperture 45 in the top (item-remote) plate 40 forms the fitting-connection port 35, and the aperture 66 in the bottom (item-adjacent) plate 60 forms the suction openings 36. The groove 57 in the intermediate plate 50, along with the adjacent lower/upper faces 44/63 of the top/bottom plates 40/60, forms the fluid channel 37. The apertures 48, 58, and 68 align and form the fastener openings 38 of the plate assembly 30. The apertures 67 on plate 60 can coordinate with electrical components (namely electrical connectors 97/98, introduced below) of the damage-detection system 90.

The plates 40, 50, 60 can be made of any suitable substrate that provides the necessary physical properties and is otherwise compatible with the manufacturing process and the intended application environment. The plates can be made of a metal (e.g. stainless steel, aluminum, etc,), a non-compressible plastic (e.g., polyethylene, polycarbonates, polyacrylics, etc.), PCB material (e.g., glass/epoxy, glass/polyester, cotton/epoxy, etc.), or any other suitable material. In the illustrated embodiment, the plate 60 can be made of a PCB material so that electrical circuitry can be printed or otherwise produced thereon. If such circuitry is incorporated into a plate, it may be desirable for the neighboring plate(s) to be non-metal to avoid the need for insulation layers. Depending upon material selection, the plates 40, 50, 60 can be machined, die-cast, or injection molded. And the apertures and groove in the respective plates can be stamped, drilled, etched, or otherwise appropriately formed.

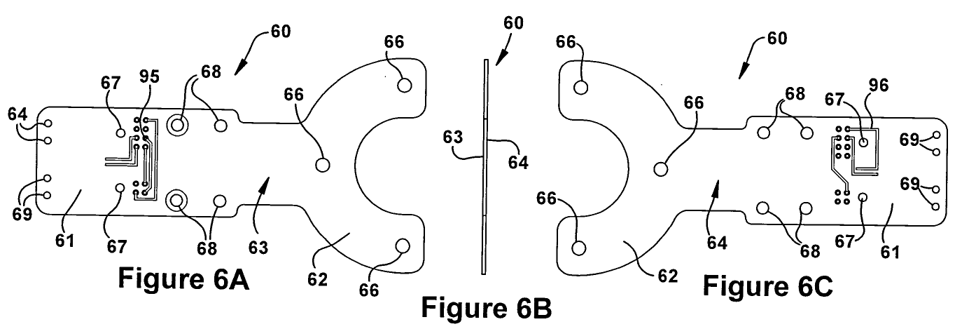

The plates 40, 50, 60 can each have an extremely small thickness. (FIGS. 4B, 5B, 6B.) For example, the plate 40 (or any plate made from a metal or plastic) can have a thickness less than 5 mm, less than 1 mm, less than 0.9 mm, and/or less than 0.8 mm. The plate 50 (or any plate made from plastic or metal) can have a thickness less than 1 mm, less than 0.9 mm, less than 0.8 mm, and/or less than 0.7 mm. The plate 60 (or any plate made from PCB material) can have a thickness less than 2 mm, less than 1.9 mm, less than 1.8 mm, less than 1.7 mm, and/or less than 1.6 mm. Accordingly, the plate assembly 30 (and thus its spatula portion 32) can have a thickness less than 5 mm and/or less than 4 mm, thereby allowing it to slip into very small clearances.

The thinness of the plates 40, 50, and 60, and the corresponding thinness of the spatula portion 32 of the plate assembly 30, may also allow the item-conveying device 30 to accommodate items 10 with non-flat surfaces 13/14. Specifically, for example, the spatula portion 32 can be somewhat flexible so as to conform to the landscape of the item's to-be-gripped surface 13/14. And with a deflection-detection system 90, the device 20 can distinguish between the flex required for item-surface conformance and an overload caused by a malfunction.

The plates 40, 50, 60 can be laminated together by any suitable laminating method, such as adhesive bonding, melt bonding, and/or ultrasonic welding. If the plates are adhesively bonded, a pressure-sensitive adhesive can be applied to facing (and non-exposed) surfaces of one of more plates (e.g., the lower surface 44 of the top plate 40, either or both upper/lower surfaces of the intermediate plate 50, and/or the upper surface 63 of the bottom plate 60). Post-adhesive-applying pressing and/or binding of the plates 40, 50, and 60 may be necessary to complete lamination and/or insure integrity of the fluid channel 37. Suitable adhesives include for example, acrylic-based adhesives such as 3M 468MP and F9473PC, and silicone-based adhesives. In any event, the fasteners 101 (or similar mechanical fasteners) preferably do not play a primary role in the attachment of the plates 40, 50, and 60 together, especially in the spatula portion 32.

An advantage of a three-plate assembly 30 (such as the illustrated three-plate structure 40/50/60) is that it has a simple construction and can be efficiently manufactured, while still having an extremely thin profile. Specifically, for example, the port-forming aperture 45 can be formed in only one plate (e.g., the item-remote plate 40) and it can extend completely through the plate's thickness. Likewise, the grip-forming apertures 66 can be formed in only one plate (e.g., the item-adjacent plate 60) and they can extend completely through the plate's thickness. And the fluid-channel-forming groove 57 can be formed in only one plate (e.g., the intermediate plate 50) and it can extend completely therethrough.

In other words, partial-thickness features are not necessary with a three-plate assembly 30. And plate-to-plate registration is only required to insure that the aperture 45 coincides with a proximal region of the groove 57 and that the apertures 66 coincide with distal regions of the groove 57. The apertures 48, 58, 68 can be formed after the plate assembly 30 is compiled to insure their registration.

That being said, other forms of the plate assembly 30 are certainly possible and contemplated, with more or less plates, plates with different aperture arrangements, modified groove geometries, etc. For example, more than one plate in the assembly 30 could have an aperture 45, more than one plate could have a groove 57, and/or more than one plate could have apertures 68. Of course, an increase in plate number may result in an increase in the thickness of the plate assembly 30 (and thus the thickness of its spatula portion 32). And/or it may add fabrication steps, registration steps, and/or lamination steps.

Additionally or alternatively, a complete-plate-thickness groove is not necessary for formation of the fluid channel 37. The groove 57 could instead extend only partially through the intermediate plate 50 (on either its upper item-remote face 53 or its lower item-adjacent face 54). If the groove 57 extended inward from the upper face 53 of the plate 50, the groove floor would form the lower boundary of the channel 37 and the lower face 44 of the top plate 40 would form the upper boundary of the channel 37. If the groove 57 extended inward from the lower face 54 of the plate 50, the groove floor would form the upper boundary of the channel 37 and the upper face 63 of the bottom plate 60 would form the lower boundary of the channel 37. In these cases, the intermediate plate 50 may also have to include apertures forming extensions of the port-defining aperture 45 and/or the suction-opening-defining apertures 66.

An incomplete-plate-thickness groove may also allow a two-plate assembly 30. For example, a partial-thickness groove 57 could extend inward from the lower face 44 of the top plate 40 (with the port-forming aperture 45 extending through the plate thickness and into the groove 57) and the upper face 63 of the bottom plate 60 could form the lower boundary of the channel 57. Or a partial thickness groove 57 could extend inward from the upper face 63 of the bottom plate 60 (with the suction-opening-forming apertures 66 extending through the plate thickness and into the groove 57) and the lower face 44 of the top plate 40 could form the upper boundary of the channel 57.

It is also possible for a partial-thickness groove 57 in one plate to align with a partial or complete thickness groove 57 in an adjacent plate to form the fluid channel 37. For example, a partial-thickness groove 57 in the lower face 44 of the top plate 40 and/or a partial-thickness groove 57 in the upper face 63 of the bottom plate 60 could align with a complete-thickness groove 57 in the intermediate plate 50. Also, with a two-plate assembly, both the lower face 44 of the top plate 40 and the upper face 63 of the bottom plate 60 could include partial-thickness grooves 57 that align to form the fluid channel 37. Such aligned partial-thickness grooves may allow an increase in the height of the fluid channel 37 without having to widen the thickness of grooved plates.

Partial-plate-thickness grooves (or any partial-plate-thickness features) can complicate fabrication steps with thin plate profiles and/or they may be difficult to obtain with tight channel-height tolerances. But in certain situations, such compromises may not be all that substantial. Or they may be worth the resulting reduction in the overall thinness of the plate assembly 30 (or at least its spatula portion 32) and/or increase in channel height.

The plate assembly 30 can also have electrical circuitry for the damage-detection system 90 being concentrated on one plate. In the illustrated plate assembly 30, for example, such electrical circuitry is printed on the upper face 63 and/or lower face 64 of the bottom (item-adjacent) plate 60. Thus, only the circuitry-carrying plate need be made of a PCB material (which often cannot be fabricated as thinly as plastic or metal plates). The other plates (e.g., upper plate 40 and intermediate plate 50) can be made of plastic or metal, which may be easier and/or more economical to manufacture and/or feature.

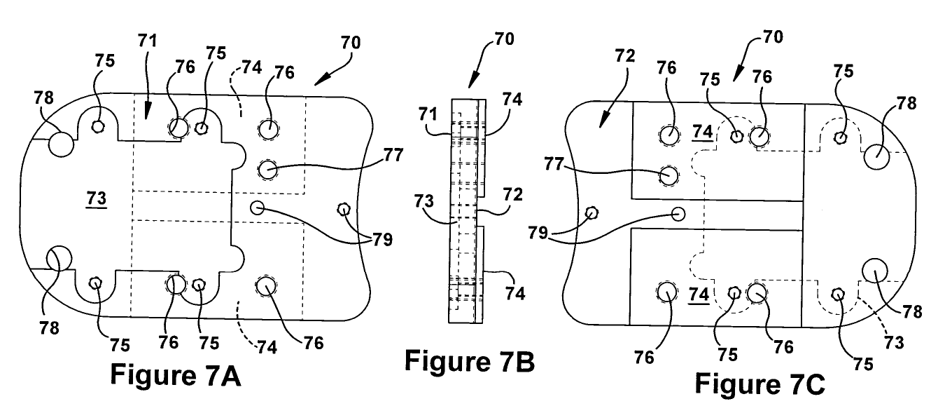

The housing 70 is shown isolated from the rest of the item-conveying device 20 in the 7^{th} drawing set (FIG. 7A-7C). The housing 70 can comprise an item-remote side 71 (e.g., the top side in the illustrated embodiment) and an item-adjacent side 72 (e.g., the bottom side in the illustrated embodiment). With the plate assembly 30 and the plates 40, 50, and 60, the orientation of the item-remote and item-adjacent surfaces/faces mirrored the acclimation of the items 10 and its intended to-be-gripped surface 13/14. With the housing 70, this may not be so much the case. Instead, the location of the housing 70 relative to the plate assembly 30 may depend more upon the bank 11 in which the items 10 reside, the movement-manipulating mechanism, and/or the space constraints within the application environment. In some instances, the cause may be better served by the housing 70 being placed adjacent to item-adjacent surface 33 of the plate assembly 30, regardless of its orientation. If so, the housing's item-remote side 71 would be its lower side, even though the item-remote surface of the plate assembly 30 is still its upper surface.

In any event, a recessed platform 73 can occupy the item-remote side 71 of the housing 70 and raised ridges 74 can reside on its item-adjacent side 72. And the housing 70 can include fastener holes 75 (for fasteners 101), fastener holes 76 (for fasteners 104), and a fitting hole 77 (for the fitting connection 110). In the illustrated housing 70, two of the fastener holes 75 coincide within the recessed platform 73 (and two do not) and all four of the fastener holes 75 coincide with the raised ridges 74. All four of the fastener holes 76 coincide with the recessed platform 73 and two of the four fastener holes 76 coincide with the raised ridges 74 (and two do not). The fitting hole 77 does not coincide with the recessed platform 73, and does coincide with one of the raised ridges 74.

The housing 70 can further include holes 78 and 79 for coordination with the damage-detection system 90. The holes 78 can be situated adjacent the housing's proximal edge, within the recessed platform 73 and outside the raised ridges 74. The holes 79 can be aligned with the furrow between the raised ridges 74.

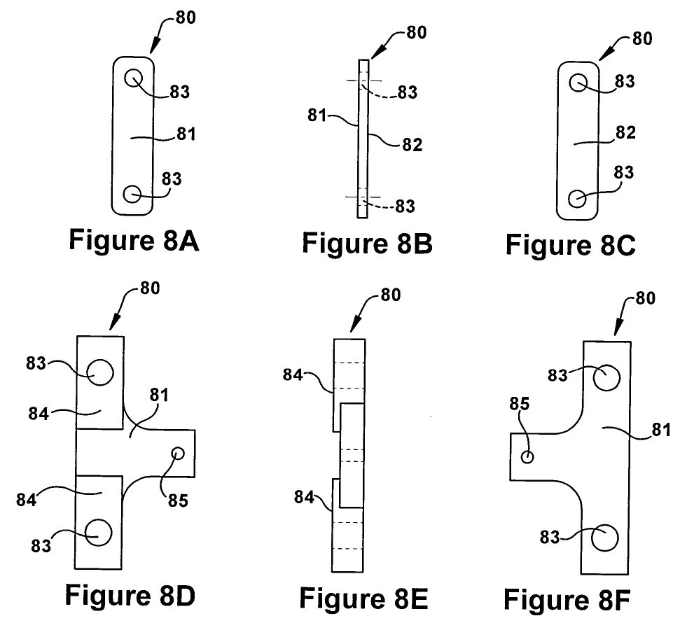

The bracket 80 is shown in the 8^{th} drawing set (FIGS. 8A-8C), and it can have an item-remote side 81 and an item-adjacent side 82. The bracket 80 shown in FIGS. 8A-8C has a roughly rectangular shape with a pair of fastener holes 83 for receipt of two of the fasteners 104. (The remaining two fasteners 104 do not extend through the bracket 80.) As is explained in more detail below, this bracket 80 can be used when the damage-detection system 90 does not include an item-remote sensor.

The bracket 80 shown in FIGS. 8D-8F can be used when the damage-detection system 90 includes an item-remote sensor. This bracket 80 has a fat-T shape, with a pair of raised ridges 84 on the head of its item-remote side 81. The fastener holes 83 coincide with the ridges 84, which also form a furrow therebetween transitioning into the stem of the T-shape. The stem can include a hole 85 for coordination with the damage-detection system 90.

The housing 70 and/or the bracket 80 can be made of a metal (metal (e.g. stainless steel, aluminum, etc,), a suitable plastic (e.g., polyethylene, etc.), or any other appropriate material. They can be formed in one piece (or not) by machining, molding, and/or casting. And the holes 75-79, 83, and 85 can be stamped, drilled, molded, etched, or otherwise suitably formed.

The damage detection system 90 is shown installed on the item-adjacent plate 60 in the 9^{th} drawing set (FIGS. 9A-9E). The system 90 comprises an electronic pressure sensor 91 that is situated above the plate's top (item-remote) face 63 and electrically arranged relative to the circuitry 95 printed thereon. The circuitry 95 is electrically connected to circuitry 96 printed on the plate's bottom (item-adjacent) face 64, which in turn is electrically connected to connectors 97 and 98. In the installed item-conveying device 20, the electrical connectors 97 would be wired or otherwise electrically connected to a controller associated within the device 20 and/or the bank 11.

The sensor 91 detects the range of deflection of the plate assembly 30, or when the plate assembly 30 reaches an unsuitable range of deflection, by the completion or incompletion of the circuit therethrough. When the plate assembly 30 is deflected within an acceptable range, the electronic pressure sensor 91 functions essentially as an inactive circuit element. When deflection reaches a predetermined point (that could potentially be damaging to the plate assembly 30 and/or the device 20), the sensor 91 forms an active circuit element. The active-inactive status of the sensor 91 is recognized and conveyed by the printing 95/96 and the connectors 97/98 to the controller.

One may now appreciate that the item-conveying device 20, and particularly the spatula portion 32 of the plate assembly 30, can be constructed to have a very thin profile, thereby allowing it to accommodate narrow clearances and/or items with uneven gripping surfaces. And the damage-detecting system 90 protects this thin (and possibly flexible) profile by discontinuing conveying steps of the device 20 in the event of a malfunction. Although the items 10, the bank 11, the conveying device 20, the device components, and steps associated therewith, have been shown and described with respect to certain embodiments, it is obvious that equivalent alterations and modifications will occur to others skilled in the art upon review of this specification and the annexed drawings. In regard to the various functions performed by the above described elements (e.g., components, assemblies, systems, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function. In addition, while a particular feature of the invention may have been described above with respect to only one or more of several illustrated embodiments, such feature may be combined with one or more other features of the other embodiments, as may be desired and advantageous for any given or particular application.

1. An item-conveying device including a plate assembly that comprises:
a plurality of thin plates adhered together to form an arm portion and a spatula portion cantilevered from the arm portion,
at least one gripping opening on an exposed item-adjacent surface of the spatula portion; and
a fluid channel extending from the arm portion to the gripping opening(s) whereby, upon connection of the fluid channel to a vacuum source, suction will be produced at the gripping opening(s) to hold an item against the spatula portion;
wherein the fluid channel is formed by a groove in a non-exposed face of at least one plate and an adjacent face of at least one neighboring plate.

2. An item-conveying device as set forth in claim 1, wherein the plurality of thin plates comprise an item-remote plate, an item-adjacent plate, and an intermediate plate therebetween, and wherein the fluid-channel-forming groove is formed in the intermediate plate.

3. An item-conveying device as set forth in claim 2, wherein the fluid-channel-forming groove extends completely through the intermediate plate.

4. An item-conveying device as set forth in claim 3, wherein the item-adjacent plate is a neighboring plate of the intermediate plate and its item-remote face forms a major wall of the fluid channel, and/or
wherein the item-remote plate is a neighboring plate of the intermediate plate, and its item-adjacent face forms a major wall of the fluid channel.

5. An item-conveying device as set forth in claim 4, wherein the item-adjacent plate comprises an aperture forming each gripping opening in the spatula portion.

6. An item-conveying device as set forth in claim 1, wherein each plate has a spatula section and an arm section, and wherein the respective arm sections are aligned with each other and the respective spatula sections are aligned with each other.

7. An item-conveying device as set forth in claim 6, wherein the spatula sections of at least some of the plates have the same plan shape and size, and/or
wherein the arm sections of at least some of the plates have the same plan shape and size.

8. An item-conveying device as set forth in claim 1, wherein the plate assembly additionally comprises a port on an exposed surface of the arm portion, and wherein the fluid channel extends between the gripping opening(s) on the spatula portion and the port on the arm portion.

9. An item-conveying device as set forth in claim 1, wherein the plates each have a thickness of less than about 5 mm.

10. An item-conveying device as set forth in claim 9, wherein at least one of the plates has a thickness of less than about 1 mm.

11. An item-conveying device as set forth in claim 10, wherein the plate assembly has a thickness of less than about 5 mm.

12. An item-conveying device as set forth in claim 11, wherein at least one of the plates is made from PCB material and has an electrical circuit printed thereon.

13. An item-conveying device as set forth in claim 1, further comprising a damage-detecting system that senses deflection of the spatula portion from the arm portion of the plate assembly.

14. An item-conveying device as set forth in claim 13, wherein the damage-detecting system comprises a pressure sensor sensing an increase in pressure upon an increase of deflection of the spatula portion relative to the arm portion.

15. An item-conveying device as set forth in claim 14, wherein the sensor is positioned between plates of the plate assembly.

16. An item-conveying device as set forth in claim 15, wherein the sensor is positioned adjacent an item-adjacent surface of the plate assembly.

17. An item-conveying device as set forth in claim 1, and a vacuum source connected to the fluid channel whereby suction is produced at the gripping opening(s) to hold an item against the spatula portion.

18. An item-conveying device as set forth in claim 17, further comprising a housing adapted for receipt of a fitting for connection to the vacuum source, the housing having an opening allowing communication between the fitting and the fluid channel in the plate assembly.

19. An item-conveying device as set forth in claim 18, wherein the plate assembly has fastening holes in its arm portion, wherein the housing has fastening holes aligned therewith, and wherein fasteners extend through the aligned holes to attach the housing to the plate assembly.

20. An item-conveying device as set forth in claim 19, further comprising a bracket including fastening holes, and wherein at least some of the fasteners extend through these fastening holes to attach the bracket to the plate assembly.
